(19) United States
(12) Patent Application Publication
(10) Pub. No.: US 2023/0127130 A1
(43) Pub. Date: Apr. 27, 2023

(54) POWER SUPPLY STATION AND TWO-WHEELED VEHICLE

(71) Applicant: OMRON Corporation, Kyoto-shi (JP)

(72) Inventors: Katsumi MATSUSHITA, Kyoto-shi (JP); Hiroyuki MINO, Kyoto-shi (JP); Atsushi NOMURA, Kyoto-shi (JP); Ryoji OKAZAKI, Kyoto-shi (JP); Eiji YASUDA, Kyoto-shi (JP)

(73) Assignee: OMRON Corporation, Kyoto-shi (JP)

(21) Appl. No.: 17/954,381

(22) Filed: Sep. 28, 2022

(30) Foreign Application Priority Data
Oct. 22, 2021 (JP) 2021-173038

(51) Int. Cl. B60L 53/122; H02J 50/10; H02J 50/00

(52) U.S. Cl. CPC B60L 53/122; H02J 50/10; H02J 50/005; B60L 2200/12

(57) ABSTRACT

A power supply station includes a power supply device that is accommodated in a housing. The power supply device includes a power supply coil that supplies electric power to a power reception device via a power reception coil, and an electric power supply circuit that supplies AC power to the power supply coil. The housing is provided with an accommodating section that accommodates the power supply coil and is provided at a position facing the power reception coil in a state in which the two-wheeled vehicle is parked at a predetermined position, and a cover section that is formed to surround at least a part including an upper end of an outer periphery of the accommodating section and to protrude toward the two-wheeled vehicle from a surface of the accommodating section on a side facing the power reception coil of the parked two-wheeled vehicle.

### CROSS-REFERENCE TO RELATED APPLICATION

This application claims priority to Japanese Patent Application No. 2021-173038 filed on Oct. 22, 2021, the entire contents of which are incorporated herein by reference.

### BACKGROUND

The disclosure relates to a power supply station for supplying power to a two-wheeled vehicle in a non-contact manner, and to a two-wheeled vehicle powered from such a power supply station.

In order to supply electric power to a two-wheeled vehicle to drive a motor that assists power in the two-wheeled vehicle, equipment that supplies electric power to a two-wheeled vehicle in a non-contact manner has been proposed. see Published PCT Application No. WO 2017/150713, and Japanese Utility Model Registration No. 3194676.

WO 2017/150713 discloses a power supply stand equipped with a power transmission circuit to supply power to a bicycle equipped with a power reception circuit. Furthermore, Japanese Utility Model Registration No. 3194676 discloses a bicycle parking rack equipped with a power supply unit having a non-connection type charging function.

### SUMMARY

In an example of a non-contact electric power supply system, a coil is provided in each of a device on a power supply side and a device on a power receiving side. Furthermore, the alternating-current (AC) power of the coil on the power supply side (hereinafter referred to as a power supply coil) is supplied in the device on the power supply side (hereinafter referred to as a power supply device) to generate a magnetic field in the power supply coil. A coil (hereinafter referred to as a power reception coil) provided in the device on the power receiving side (hereinafter referred to as a power reception device) resonates with the magnetic field, and electric power is thereby supplied from the power supply device to the power reception device in a non-contact manner.

In such a non-contact power supply device, if metallic foreign matter enters between the power supply coil on the power transmitting side and the power reception coil on the power receiving side, the foreign matter is heated by induction heating during power transmission, which may cause abnormal heat generation or deformation of the cover of the device.

Accordingly, a power supply station according to one or more embodiments is disclosed that may suppress foreign matter from entering between the power reception coil provided in a two-wheeled vehicle and the power supply coil, while enabling non-contact power supply to the two-wheeled vehicle via the power supply coil.

One or more embodiments relates to a power supply station capable of supplying power to a power reception device that includes a power reception coil and is provided in a two-wheeled vehicle. This power supply station includes a power supply device that supplies electric power to a power reception device and a housing that accommodates the power supply device. The power supply device includes a power supply coil that supplies electric power to a power reception device via a power reception coil and an electric power supply circuit that supplies AC power to the power supply coil. Furthermore, the housing includes an accommodating section that accommodates the power supply coil and that is provided at a position facing the power reception coil in a state in which the two-wheeled vehicle is parked at a predetermined position, and a cover section that is formed to surround at least a part including an upper end of an outer periphery of the accommodating section and to protrude toward the two-wheeled vehicle from a surface of the accommodating section on a side facing the power reception coil in a state in which the two-wheeled vehicle is parked at the predetermined position.

According to such a configuration, the power supply station may suppress foreign matter from entering between the power reception coil provided in the two-wheeled vehicle and the power supply coil, while enabling non-contact power supply to the two-wheeled vehicle via the power supply coil.

In a power supply station according to one or more embodiments, it may be preferable that the housing further includes a door section that is openably and closably attached to the cover section to cover the surface of the accommodating section in the state in which the two-wheeled vehicle is not parked at the power supply station, and not to cover the surface of the accommodating section in the state in which the two-wheeled vehicle is parked at the predetermined position.

According to such a configuration, the power supply station may suppress foreign matter from adhering to the surface of the accommodating section in the state in which the two-wheeled vehicle is not parked, and therefore may more reliably suppress foreign matter from entering between the power reception coil provided in the two-wheeled vehicle and the power supply coil.

One or more embodiments relates to a power supply station capable of supplying power to a power reception device that includes a power reception coil and is provided in a two-wheeled vehicle. The power supply station includes a power supply device that supplies electric power to a power reception device and a housing that accommodates the power supply device. The power supply device includes a power supply coil that supplies electric power to a power reception device via a power reception coil and an electric power supply circuit that supplies AC power to the power supply coil. Furthermore, the housing includes an accommodating section that accommodates the power supply coil and that is provided at a position facing the power reception coil in a state in which the two-wheeled vehicle is parked at a predetermined position. Furthermore, the surface of the accommodating section on a side facing the power reception coil is formed to be tilted downward by a predetermined angle with respect to the normal of a road surface on which the power supply station is installed.

According to such a configuration, the power supply station may suppress foreign matter from entering between the power reception coil provided in the two-wheeled vehicle and the power supply coil, while enabling non-contact power supply to the two-wheeled vehicle via the power supply coil.

One or more embodiments relates to a two-wheeled vehicle with a front wheel and a rear wheel, which uses electric power for traveling. The two-wheeled vehicle includes a power reception device including a power reception coil for receiving electric power in a non-contact manner from a power supply coil provided in a power supply station, an accommodating section that accommodates the power reception coil, and a cover section formed to surround at least a part including an upper end of an outer periphery of the accommodating section and to protrude from a surface of the accommodating section.

According to such a configuration, the two-wheeled vehicle may suppress foreign matter from entering between the power supply coil provided in the power supply station and the power reception coil, when receiving electric power from the power supply station.

In a two-wheeled vehicle according to one or more embodiments, it may be preferable that the cover section is a front basket provided above the front wheel at an interval from the front wheel and that the accommodating section is arranged between the front wheel and the front basket.

According to such a configuration, even if the cover section is not provided separately from the front basket around the accommodating section that accommodates the power reception device, the two-wheeled vehicle may suppress foreign matter from entering between the power supply coil provided in the power supply station and the power reception coil when receiving electric power from the power supply station, since the front basket functions as the cover section.

### BRIEF DESCRIPTION OF THE DRAWINGS

FIG. 1 is a schematic configuration diagram illustrating a non-contact power supply system including a power supply station and a two-wheeled vehicle according to one or more embodiments.

FIG. 2 is a schematic diagram illustrating a front view of a power supply station as viewed from a parked two-wheeled vehicle side.

FIG. 3 is a schematic diagram illustrating a side view of a power supply station.

FIG. 4 is a schematic diagram illustrating a perspective view of a power supply station, in a state where a two-wheeled vehicle is parked at a power supply station.

FIG. 5 is a diagram illustrating an enlarged view of a power supply station and a part of a two-wheeled vehicle, which are related to a supply of electric power from a power supply station to a two-wheeled vehicle.

FIG. 6A is a diagram illustrating a front view of an accommodating section and a cover of a power supply station according to a variation.

FIG. 6B is a diagram illustrating a bottom view of an accommodating section and a cover as viewed from below.

FIG. 7A is a schematic diagram illustrating a side view of a power supply station according to another variation.

FIG. 7B is a schematic front view of a power supply station according to another variation.

FIG. 7C is a schematic diagram illustrating a side view of a vicinity of an accommodating section according to another variation.

FIG. 7D is a schematic diagram illustrating a front view of a vicinity of an accommodating section according to another variation.

FIG. 8 is a diagram illustrating an enlarged view of a power supply station and a two-wheeled vehicle, according to yet another variation.

### DETAILED DESCRIPTION OF EMBODIMENTS

Hereinafter, a power supply station according to one or more embodiments will be described with reference to the drawings. The power supply station includes a power supply device for supplying power to a two-wheeled vehicle, inside a housing formed to specify a position where the two-wheeled vehicle is parked, and a power supply coil of the power supply device is accommodated in an accommodating section of the housing provided at a position facing a power reception coil of the parked two-wheeled vehicle. Furthermore, in the housing, a cover section is formed to surround at least a part of the outer periphery of the accommodating section, including an upper end of the accommodating section, and is formed to protrude toward the two-wheeled vehicle from the surface of the accommodating section on a side facing the power reception coil in a state in which the two-wheeled vehicle is parked at a predetermined position. As a result, the power supply station suppresses foreign matter from adhering to the surface of the accommodating section located between the power supply coil and the power reception coil during power supply, and suppresses foreign matter from entering between the power reception coil and the power supply coil.

The two-wheeled vehicle powered by the power supply station may be anything that uses electric power for traveling. For example, the two-wheeled vehicle may be an electrically assisted bicycle that assists a user with a motor, a scooter or a motorcycle having a motor. In the following example, the two-wheeled vehicle is assumed to be an electrically assisted bicycle.

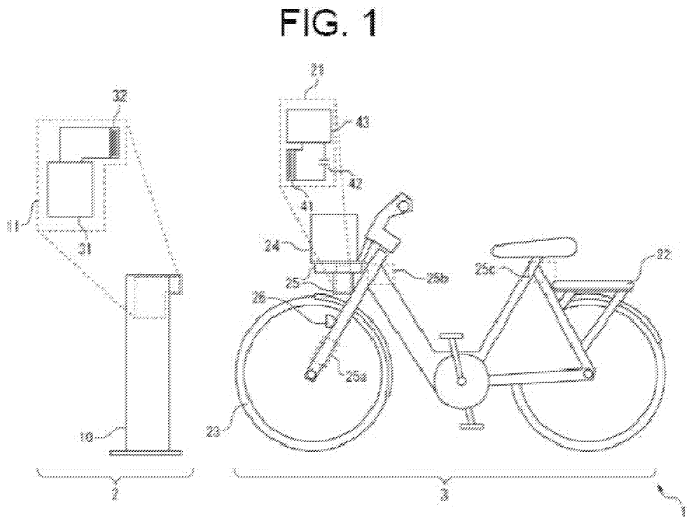

FIG. 1 is a schematic configuration diagram of a non-contact power supply system including a power supply station and a two-wheeled vehicle according to the present embodiment.

As illustrated in FIG. 1, a non-contact power supply system 1 includes a power supply station 2 and a two-wheeled vehicle 3 with front and rear wheels. The power supply station 2 is capable of supplying power to the two-wheeled vehicle 3, and includes a housing 10 and a power supply device 11 that is provided inside the housing 10. Meanwhile, the two-wheeled vehicle 3 uses electric power for traveling, and accordingly includes a power reception device 21 and a battery 22 for storing the electric power received by the power reception device 21. The electric power stored in the battery 22 is used to drive a motor (not illustrated) that provides auxiliary power for the two-wheeled vehicle 3 or to turn on a headlight 26. Power is supplied from the power supply device 11 to the power reception device 21 in a non-contact manner by the two-wheeled vehicle 3 being parked at a position specified by the housing 10 of the power supply station 2.

The power supply device 11 includes an electric power supply circuit 31 and a power supply coil 32. Meanwhile, the power reception device 21 includes a power reception coil 41, a resonance capacitor 42, and a power reception circuit 43. The power reception coil 41 constitutes a resonance circuit together with the resonance capacitor 42. For example, the power supply device 11 and the power reception device 21 can be a non-contact power supply device of a so-called primary series secondary series resonance capacitor system (SS type) or a so-called primary series secondary parallel resonance capacitor system (SP type). Alternatively, the power supply device 11 and the power reception device 21 may be a non-contact power supply device in which the power reception coil 41 and the resonance capacitor 42 resonate in series on the power receiving side (NS type) instead of using the resonance on the power supply side, or may be a non-contact power supply device in which the power reception coil 41 and the resonance capacitor 42 resonate in parallel on the power receiving side (NP type) instead of using the resonance on the power supply side.

First, the power supply device 11 provided in the power supply station 2 will be described.

The electric power supply circuit 31 supplies AC power to the power supply coil 32. Accordingly, the electric power supply circuit 31 includes, for example, a full-wave rectifier circuit that converts AC power supplied from a commercial power source into pulsating electric power, a power factor improvement circuit that improves the power factor of the pulsating power output from the full-wave rectifier circuit to thereby convert the pulsating power into direct-current (DC) power and boost same, an inverter circuit that converts DC power supplied from the power factor improvement circuit into AC power with a predetermined frequency and supplies same to the power supply coil 32, and a control circuit that controls the power factor improvement circuit and the inverter circuit. The inverter circuit may be a full-bridge inverter in which four switching elements (e.g., MOSFETs) are connected in a full-bridge shape, or may be a half-bridge inverter in which two switching elements are connected in a half-bridge shape. The control circuit controls on/off switching of each switching element of the inverter circuit in such a manner that the frequency of the AC power supplied to the power supply coil 32 becomes a predetermined frequency (e.g., the frequency at which the resonance circuit of the power reception device 21 resonates). The control circuit may further control the power factor improvement circuit to adjust the voltage of the DC power supplied to the inverter circuit to keep the voltage of the electric power received by the power reception device 21 constant.

The electric power supply circuit 31 may further include a DC-DC converter for boosting or lowering the voltage of the DC power output from the power factor improvement circuit, between the power factor improvement circuit and the inverter circuit. Alternatively, the electric power supply circuit 31 may include an AC-DC converter that converts AC power supplied from a commercial AC power source to DC power, instead of the rectifier circuit and the power factor improvement circuit. Alternatively, the electric power supply circuit 31 may also include a DC power source to supply DC power, such as a lithium-ion secondary battery or lead acid battery, and a DC-DC converter that boosts or lowers the voltage of the DC power supplied from the DC power source, instead of the rectifier circuit and the power factor improvement circuit.

The power supply coil 32 transmits the AC power supplied from the electric power supply circuit 31 to the power reception coil 41 of the power reception device 21 via a space. The power supply device 11 may have a capacitor connected in series with the power supply coil 32 between the power supply coil 32 and the inverter circuit of the electric power supply circuit 31. The capacitor may be for cutting off DC power, or may be for forming a resonance circuit that resonates with the power supply coil 32 at the frequency of the AC power supplied to the power supply coil 32.

The power supply device 11 may further include a communicator that receives signals indicating the power reception status by the power reception device 21. Accordingly, the control circuit of the electric power supply circuit 31 may change the on/off switching timing of each switching element of the inverter circuit to change the frequency of the AC power supplied to the power supply coil 32 in accordance with the power reception status.

Next, the power reception device 21 provided in the two-wheeled vehicle 3 will be described.

The two-wheeled vehicle 3 is provided with a front basket 24 above the front wheel 23 at an interval from the front wheel 23, and a box 25 formed of an insulator such as resin is attached to the lower surface of the front basket 24. The power reception device 21 is accommodated in the box 25. Furthermore, the power reception coil 41 of the power reception device 21 is attached to the two-wheeled vehicle 3 between the front wheel 23 and the front basket 24 of the two-wheeled vehicle 3 in such a manner that the winding axis of the power reception coil 41 faces the front of the two-wheeled vehicle 3. Thus, since the power reception coil 41 is accommodated in the box 25 arranged between the front wheel 23 and the front basket 24, foreign matter is suppressed from entering between the power supply coil 32 provided in the power supply station 2 and the power reception coil 41 when the two-wheeled vehicle 3 receives electric power from the power supply station 2. The box 25 is an example of the accommodating section that accommodates the power reception coil 41. Furthermore, the front basket 24 is an example of the cover section that is formed to surround at least a part including the upper end of the outer periphery of the accommodating section that accommodates the power reception coil 41 and to protrude from the surface of the accommodating section.

The power reception coil 41 constitutes a resonance circuit together with the resonance capacitor 42, and resonates with the alternating current flowing through the power supply coil 32 of the power supply device 11 to thereby receive electric power from the power supply coil 32. The resonance capacitor 42 may be connected in series with the power reception coil 41 or in parallel with the power reception coil 41. Accordingly, the AC power output from the resonance circuit formed by the power reception coil 41 and the resonance capacitor 42 is output to the power reception circuit 43. The number of turns of the power reception coil 41 and the number of turns of the power supply coil 32 may be equal or different from each other.

The power reception circuit 43 converts the AC power from the resonance circuit formed by the power reception coil 41 and the resonance capacitor 42 into DC power, and outputs the DC power to the battery 22 that is connected to the power reception circuit 43 via a power cable (not illustrated) and is installed on the loading platform provided on the upper surface of the rear wheel. For example, the power reception circuit 43 includes a full-wave rectifier circuit that converts AC power from the resonance circuit into pulsating electric power, and a smoothing capacitor for smoothing the pulsating electric power output from the full-wave rectifier circuit and outputting same to the battery 22. Furthermore, the power reception circuit 43 may include a voltmeter for measuring the voltage output to the battery 22, a communicator for transmitting a signal indicating the power reception status, such as the voltage measured by the voltmeter to the power supply device 11, a switching element for switching the connection or disconnection between the battery 22 and the power reception circuit 43, a control circuit that controls on/off switching of the switching element, and the like.

Hereinafter, a configuration of the power supply station 2 will be described.

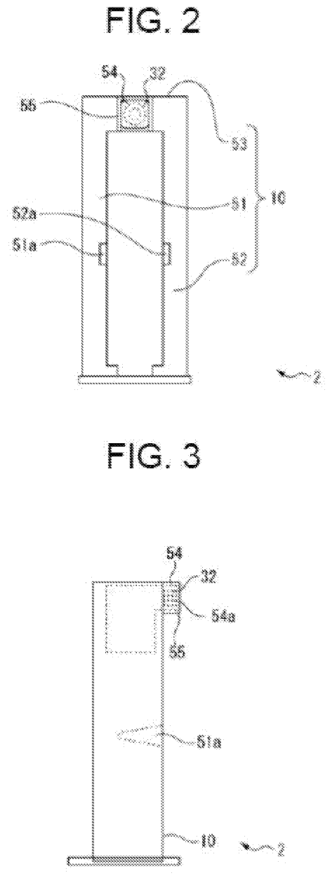

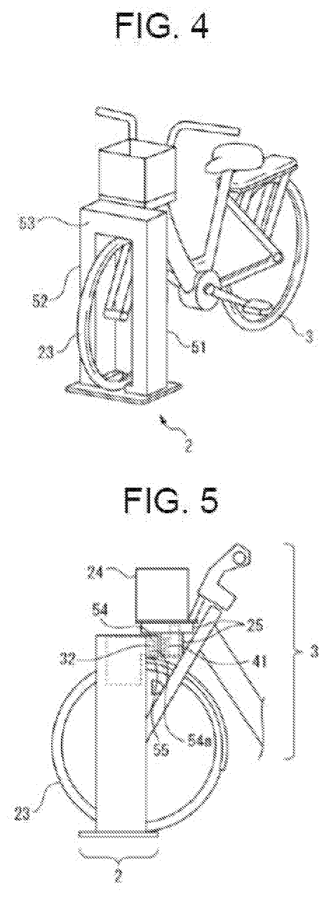

FIG. 2 is a schematic front view of the power supply station 2 as viewed from the parked two-wheeled vehicle 3 side. FIG. 3 is a schematic side view of the power supply station 2. FIG. 4 is a schematic perspective view of the power supply station 2, illustrating a state where the two-wheeled vehicle 3 is parked at the power supply station 2. FIG. 5 is an enlarged view illustrating the power supply station 2 and a part of the two-wheeled vehicle 3, which are related to the supply of electric power from the power supply station 2 to the two-wheeled vehicle 3 in a state where the two-wheeled vehicle 3 is parked at the power supply station 2. In the following, the surface of the housing 10 on the side facing the two-wheeled vehicle 3 parked at the power supply station 2 may be referred to as the front surface of the housing 10.

The housing 10 of the power supply station 2 is formed to specify a predetermined position where the two-wheeled vehicle 3 is parked. In the present embodiment, as illustrated in FIGS. 2 to 4, the housing 10 has an inverted U shape as a whole when viewed from the front side. The housing 10 is provided in a substantially vertical direction with respect to the road surface on which the power supply station 2 is installed, and the housing 10 is configured to include two support column sections 51 and 52 having a substantially square columnar shape and an upper end section 53 connecting the two support column sections 51 and 52 at the upper portions thereof. In the state in which the two-wheeled vehicle 3 is parked at the power supply station 2, the front wheel of the two-wheeled vehicle 3 is inserted into the gap section between the two support column sections 51 and 52 of the housing 10. In other words, the gap section between the two support column sections 51 and 52 indicates the position of the front wheel of the two-wheeled vehicle 3 when the two-wheeled vehicle 3 is parked.

The support column sections 51 and 52 and the upper end section 53 are respectively formed in a hollow shape by a metal such as iron, aluminum or stainless steel, a resin, or a material obtained by combining them. A power cable (not illustrated) for transmitting electric power from a commercial power source or a DC power source to the power supply device 11 is accommodated inside one of the support column sections 51 and 52. Furthermore, a board (not illustrated) is attached to the inside of the support column sections 51 and 52 or the upper end section 53, and the electric power supply circuit 31 of the power supply device 11 is provided on the board. Grooves 51a and 52a formed to engage with the shaft of the front wheel 23 of the two-wheeled vehicle 3 in the state in which the two-wheeled vehicle 3 is parked may be provided on the surfaces of the support column sections 51 and 52 on the side facing each other. The grooves 51a and 52a may be formed in such a manner that the width becomes narrower as the groove approaches the surface opposite to the front side (hereinafter referred to as a back side) from the front side.

On the front side of the upper end section 53 of the housing 10, a substantially rectangular cuboid-shaped accommodating section 54 is formed to protrude toward the two-wheeled vehicle 3 to be parked, in such a manner that the power reception coil 41 of the two-wheeled vehicle 3 parked at the power supply station 2 and the power supply coil 32 face each other. The power supply coil 32 is accommodated inside the accommodating section 54. At that time, the power supply coil 32 is installed in such a manner that its winding axis is orthogonal to the surface 54a (hereinafter, it may be referred to as a surface) on the front side of the accommodating section 54. The accommodating section 54 is formed of an insulator such as resin not to be affected by the power supply from the power supply device 11 to the power reception device 21.

Furthermore, the accommodating section 54 is formed with a cover 55 that protrudes further toward the two-wheeled vehicle 3 side than the surface 54a of the accommodating section 54 to surround at least a part including the upper end of the outer periphery thereof.

The cover 55 is an example of the cover section and is formed of an insulator such as resin or a metal such as aluminum that has negligible effect on the power supply, to have an inverted U shape when viewed from the front side. In other words, the cover 55 is configured to include a plate-like member that extends from the upper end to the lower end of the accommodating section 54 on each of the right and left side surfaces of the accommodating section 54, and a plate-like member provided on the upper side of the accommodating section 54. The cover 55 is provided to protrude from the surface 54a of the accommodating section 54 by about a few centimeters to 10 centimeters toward the two-wheeled vehicle 3 side. By providing such a cover 55 around the accommodating section 54, foreign matter is suppressed from adhering to the surface 54a of the accommodating section 54, which is located between the power supply coil 32 and the power reception coil 41 when power is supplied from the power supply device 11 to the power reception device 21.

According to a variation, the cover 55 may be provided only on the upper side of the accommodating section 54. Alternatively, the member of the cover 55 that is provided on each of the right and left side surfaces of the accommodating section 54 may not be extended to the lower end of the accommodating section 54. For example, the member of the cover 55 that is provided on each of the right and left side surfaces of the accommodating section 54 may be formed to cover the accommodating section 54 from the upper end of the accommodating section 54 to near the midpoint in the height direction of the accommodating section 54. Even in the above-described variation, the cover 55 can suppress foreign matter from adhering to the surface 54a of the accommodating section 54.

As described above, the power supply station includes the power supply coil for non-contact power supply to the parked two-wheeled vehicle, in the accommodating section of the housing of the power supply station. The cover section is provided around the accommodating section to cover at least the upper side of the surface of the accommodating section of the housing, which is located between the power reception coil for the parked two-wheeled vehicle to receive electric power and the power supply coil. Therefore, foreign matter is suppressed from adhering to the surface of the accommodating section, which is located between the power supply coil and the power reception coil at the time of power supply. Therefore, the power supply station can suppress foreign matter from entering between the power reception coil provided in the two-wheeled vehicle and the power supply coil, while enabling non-contact power supply to the two-wheeled vehicle via the power supply coil.

According to a variation, the cover 55 provided on the accommodating section 54 of the housing 10 of the power supply station 2 may be provided with a door that can be opened and closed in front of the surface 54a of the accommodating section 54. The door is provided to be closed when the two-wheeled vehicle 3 is not parked at the power supply station 2. On the other hand, the door is provided to be opened when the two-wheeled vehicle 3 is parked at the power supply station 2.

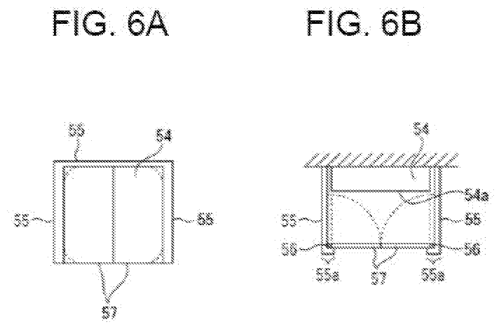

FIG. 6A is a front view of the accommodating section 54 and the cover 55 of the power supply station 2 according to the above-described variation. Furthermore, FIG. 6B is a bottom view of the accommodating section 54 and the cover 55 as viewed from below. In the variation, a rotatable door 57 is attached at the tip of each of the right and left members of the cover 55 via a rotary shaft 56 provided along the vertical direction. In other words, the door 57 is opened and closed by a so-called double door. A spring (not illustrated) is wound around the rotary shaft 56, one end of the spring is fixed to the inner surface of the right and left members of the cover 55, and the other end of the spring is fixed to the inner surface of the door 57. Then, at the tips of the right and left members of the cover 55, an L-shaped stopper 55a for preventing the door 57 from opening outward is formed in the vicinity of one end of the door 57 on the rotary shaft 56 side. Therefore, in the state in which the two-wheeled vehicle 3 is not parked at the power supply station 2, the door 57 is closed and the surface 54a of the accommodating section 54 will be covered by the cover 55 and the door 57. The door 57 is an example of the door section.

In the present example, in the box 25 of the two-wheeled vehicle 3, when the two-wheeled vehicle 3 is viewed from the left side as illustrated in, for example, FIG. 1, the section in which the power reception coil 41 is accommodated is formed in an inverted L shape, in such a manner that a recess-shaped section is formed between the section in which the power reception coil 41 is accommodated and the section fixed to the lower surface of the front basket 24. In other words, in the state in which the two-wheeled vehicle 3 is parked at the power supply station 2, the box 25 is formed in such a manner that the tip of the cover 55 is inserted in the recess-shaped section. Then, when the two-wheeled vehicle 3 is brought close to the power supply station 2 in order to be parked at the power supply station 2, the tip of the portion of the box 25 in which the power reception coil 41 is accommodated pushes the door 57 with that approach, and the door 57 thereby opens toward the inside of the cover 55. Then, as the two-wheeled vehicle 3 moves to a position where the front wheel 23 of the two-wheeled vehicle 3 is inserted into the gap section of the power supply station 2 to a predetermined extent or more, the door 57 is completely opened, and the power supply coil 32 and the power reception coil 41 come to face each other via the surface 54a of the accommodating section 54, and power can be supplied from the power supply coil 32 via the power reception coil 41.

According to the above-described variation, in the state in which the two-wheeled vehicle 3 is not parked at the power supply station 2, the surface 54a of the accommodating section 54 in which the power supply coil 32 is accommodated is covered not only by the cover 55 but also by the door 57. Therefore, foreign matter is more reliably suppressed from adhering to the surface 54a.

The cover 55 may be provided to surround the entire outer periphery of the accommodating section 54. The door may be rotatably attached via a rotary shaft (not illustrated) provided horizontally at the tip of each of the upper and lower members of the cover 55. Furthermore, the door may be opened and closed by sliding.

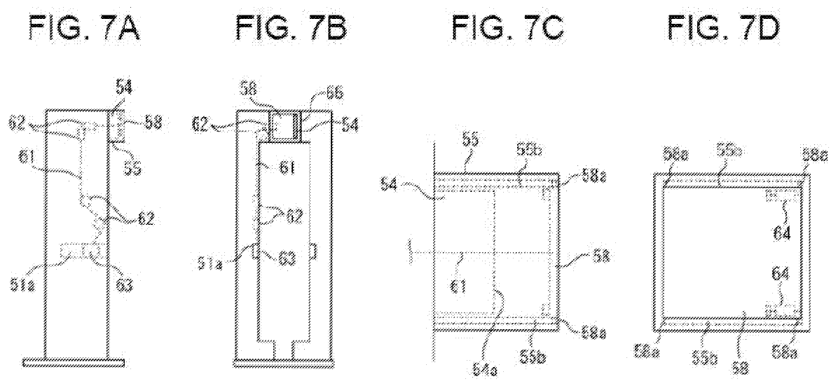

FIGS. 7A and 7B are respectively a schematic side view and a schematic front view of the power supply station 2 according to another variation. FIGS. 7C and 7D are respectively a schematic side view and a schematic front view of the vicinity of the accommodating section according to another variation. In the above-described variation, the cover 55 is provided to surround the entire outer periphery of the accommodating section 54. Furthermore, a groove-shaped rail 55b is formed at the tips of the upper and lower members of the cover 55 and along the left side of the accommodating section 54 when viewed from the front side in those members. Furthermore, a door 58 is provided to be movable along the rail 55b and to cover the surface 54a of the accommodating section 54 in a state where the two-wheeled vehicle 3 is not parked. The door 58 is another example of the door section.

At the two top corners of the door 58, an engagement member 58a that projects upwardly to engage with the rail 55b is provided. Similarly, at the two bottom corners of the door 58, an engagement member 58a that projects downwardly to engage with the rail 55b is provided. Furthermore, one end of the wire 61 is coupled to the substantially central portion of the left end of the door 58 when viewed from the front side. The wire 61 is supported by a plurality of pulleys 62 provided in the housing 10, and the other end of the wire 61 is attached to a moving member 63 provided to be movable along the groove 51a that is provided in the support column section 51 of the housing 10 and that engages with the shaft of the front wheel of the two-wheeled vehicle 3. Furthermore, the upper and lower vicinities of the right end of the door 58 are connected to the right-side member of the cover 55 by a winding spring 64, respectively.

Therefore, the door 58 is rested at a position covering the surface 54a of the accommodating section 54 by the tensile force of the winding spring 64 in the state in which the two-wheeled vehicle 3 is not parked at the power supply station 2. On the other hand, in the state in which the two-wheeled vehicle 3 is parked at the power supply station 2, the shaft of the front wheel of the two-wheeled vehicle 3 engages with the moving member 63 to move the moving member 63 from the front side to the back side, and thus the door 58 is pulled to the left via the wire 61, and the door 58 thereby slides and moves to a position along the inside of the left side member of the cover 55. The above-described configuration may allow the power supply coil 32 and the power reception coil 41 to face each other via the surface 54a of the accommodating section 54, and power supply from the power supply coil 32 via the power reception coil 41 may become possible.

In the above-described variation, in the state in which the two-wheeled vehicle 3 is not parked at the power supply station 2, the surface 54a of the accommodating section 54 in which the power supply coil 32 is accommodated is covered not only by the cover 55 but also by the door 58. Therefore, foreign matter is more reliably suppressed from adhering to the surface 54a. Furthermore, in the above-described variation, the door 58 slides and moves when the door 58 opens, and thus the distance from the surface 54a of the accommodating section 54 to the door 58 can be shortened.

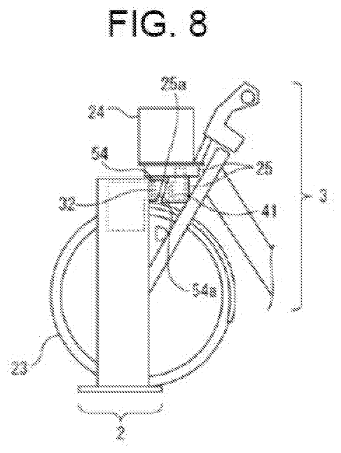

According to yet another variation, the surface 54a of the accommodating section 54 may be tilted to face downward. FIG. 8 is an enlarged view illustrating a power supply station 2 and a two-wheeled vehicle 3, according to the present variation.

In the illustrated variation, the surface 54a of the accommodating section 54 in which the power supply coil 32 is accommodated is tilted downward by a predetermined angle with respect to the normal of the road surface on which the power supply station 2 is installed. The predetermined angle can be, for example, about 10 to 30 degrees. Meanwhile, the surface 25a of the box 25 in which the power reception coil 41 is accommodated as viewed from the front side of the two-wheeled vehicle 3 is also tilted upward by a predetermined angle with respect to the normal direction of the road surface to be substantially parallel to the surface 54a of the accommodating section 54 in the state in which the two-wheeled vehicle 3 is parked at the power supply station 2. As with the above embodiment, the power supply coil 32 in the accommodating section 54 may be installed in such a manner that its winding axis is parallel to the road surface, or in such a manner that the winding axis is orthogonal to the surface 54a of the accommodating section 54. Furthermore, the power reception coil 41 in the box 25 may be installed in such a manner that its winding axis is parallel to the road surface, or in such a manner that the winding axis is orthogonal to the surface 54a of the box 25.

Furthermore, in the above-described variation, the cover surrounding the accommodating section 54 is omitted. As with the above embodiment, the cover surrounding the accommodating section 54 may also be provided.

According to the above-described variation, the surface 54a of the accommodating section 54, which is located between the power supply coil 32 and the power reception coil 41 at the time of power supply, is tilted downward, and thus foreign matter is suppressed from adhering to the surface 54a. The box 25 in which the power reception coil 41 is accommodated is attached below the front basket 24 of the two-wheeled vehicle 3, and thus even if the surface 25a of the box 25 is tilted upward, the presence of the front basket 24 above the surface 25a suppresses the adhesion of foreign matter. Therefore, the power supply station can suppress foreign matter from entering between the power reception coil provided in the two-wheeled vehicle and the power supply coil.

Furthermore, in the above embodiment or embodiments and each of the variations, the housing of the power supply station may have a shape different from the shapes described above. For example, one of the two support column sections of the housing may be omitted. As an alternative to that, a front wheel rail to engage the front wheel of the two-wheeled vehicle 3 may be provided on the road surface to locate where the front wheel of the two-wheeled vehicle 3 should be positioned when parked. According to yet another variation, a housing may be formed as a single support column at a position facing the front wheel of the two-wheeled vehicle 3 engaged with the front wheel rail from the front, and at the upper end of the housing, an accommodating section in which the power supply coil 32 is accommodated may be provided to protrude toward the two-wheeled vehicle 3 side. Even if the housing of the power supply station has such a shape, the power supply station can have the same effect as that of the embodiment or embodiments, or variations described above.

Furthermore, in the two-wheeled vehicle 3, the box 25 that is an example of the accommodating section accommodating the power reception coil 41 may be attached on the side surface of the two-wheeled vehicle 3 in such a manner that the winding axis of the power reception coil 41 faces the side direction of the two-wheeled vehicle 3.

Referring to FIG. 1 again, for example, the box 25 may be attached to a frame supporting the shaft of the front wheel of the two-wheeled vehicle 3 at a position 25a indicated by the dotted line. Alternatively, the box 25 may be attached to the frame of the two-wheeled vehicle 3 at a position 25b indicated by the dotted line below the handlebars or at a position 25c indicated by the dotted line below the saddle. Accordingly, a cover section that is formed to surround at least a part including the upper end of the outer periphery of the box 25 and to protrude from the surface of the box 25 is provided. For example, as with the cover 55 of the power supply station 2 in the above embodiment, the cover section may be formed of an insulator such as resin or a metal such as aluminum that has negligible effect on the power supply, so as to have an inverted U shape when viewed from the surface side of the box 25.

The housing of the power supply station is formed as a single support column at a position facing the side of the two-wheeled vehicle 3 that is engaged with the front wheel rail provided on the road surface. On the surface of the housing on the side facing the parked two-wheeled vehicle 3, an accommodating section in which the power supply coil 32 is accommodated and a cover section surrounding the accommodating section may be provided to protrude toward the two-wheeled vehicle 3 side.

A person skilled in the art may make various modifications in accordance with an embodiment or embodiments that are considered to fall within the scope of the present disclosure.

What is claimed is:

1. A power supply station capable of supplying power to a power reception device that comprises a power reception coil and is provided on a two-wheeled vehicle, the power supply station comprising:
a power supply device that supplies electric power to the power reception device; and
a housing that accommodates the power supply device, wherein
the power supply device comprises:
a power supply coil that supplies electric power to the power reception device via the power reception coil; and
an electric power supply circuit that supplies alternating-current power to the power supply coil, and
the housing comprises:
an accommodating section that accommodates the power supply coil and is provided at a position facing the power reception coil in a state in which the two-wheeled vehicle is parked at a predetermined position; and
a cover section that is formed to surround at least a part including an upper end of an outer periphery of the accommodating section and to protrude toward the two-wheeled vehicle from a surface of the accommodating section on a side facing the power reception coil in a state in which the two-wheeled vehicle is parked at the predetermined position.

2. The power supply station according to claim 1, wherein the housing further comprises a door section that is openably and closably attached to the cover section to cover the surface of the accommodating section in a state in which the two-wheeled vehicle is not parked at the power supply station, and not to cover the surface of the accommodating section in a state in which the two-wheeled vehicle is parked at the predetermined position.

3. A power supply station capable of supplying power to a power reception device that comprises a power reception coil and is provided on a two-wheeled vehicle, the power supply station comprising:
a power supply device that supplies electric power to the power reception device; and
a housing that accommodates the power supply device, wherein
the power supply device comprises:
a power supply coil that supplies electric power to the power reception device via the power reception coil; and
an electric power supply circuit that supplies alternating-current power to the power supply coil, and
the housing comprises an accommodating section that accommodates the power supply coil and is provided at a position facing the power reception coil in a state in which the two-wheeled vehicle is parked at a predetermined position, a surface of the accommodating section on a side facing the power reception coil is formed to be tilted downward by a predetermined angle with respect to a normal of a road surface on which the power supply station is installed.

4. A two-wheeled vehicle with a front wheel and a rear wheel, which uses electric power for traveling, the two-wheeled vehicle comprising:
a power reception device that comprises a power reception coil for receiving electric power in a non-contact manner from a power supply coil provided in a power supply station;
an accommodating section that accommodates the power reception coil; and
a cover section formed to surround at least a part including an upper end of an outer periphery of the accommodating section and to protrude from a surface of the accommodating section.

5. The two-wheeled vehicle according to claim 4,
wherein the cover section is a front basket provided above the front wheel at an interval from the front wheel, and
wherein the accommodating section is arranged between the front wheel and the front basket.
